(19) United States
(12) Patent Application Publication
(10) Pub. No.: US 2026/0247385 A1
(43) Pub. Date: Aug. 20, 2026

(54) RESOURCE POOL CONFIGURATIONS FOR CONNECTIONLESS COMMUNICATIONS IN WIRELESS NETWORKS

(71) Applicant: QUALCOMM Incorporated, San Diego, CA (US)

(72) Inventors: Diana MAAMARI, San Diego, CA (US); Gabi SARKIS, San Diego, CA (US); Jing SUN, San Diego, CA (US); Linhai HE, San Diego, CA (US); Mickael MONDET, Louannec (FR)

(21) Appl. No.: 19/057,394

(22) Filed: Feb. 19, 2025

(51) Int. Cl. H04W 72/21; H04W 24/10; H04W 72/115

(52) U.S. Cl. CPC H04W 72/21; H04W 24/10; H04W 72/115

(57) ABSTRACT

A method of wireless communication performed by a wireless communication device comprises receiving, at a buffer for uplink (UL) transmissions, UL data associated with a first logical channel of a plurality of logical channels. The method further comprises transmitting, to a network unit and based on a common UL data resource pool, the UL data. The transmitting the UL data is based on a connectionless UL data transmission configuration. In some aspects, the connectionless UL data transmission configuration indicates that the first logical channel is configured for transmission using the common UL data resource pool.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

A UE may operate in one of a plurality of connection modes or states to conserve power and network resources. For example, if a UE is not scheduled to receive downlink (DL) communications or to transmit uplink (UL) communications, the UE may be moved into an idle mode or an inactive mode. The network may move the UE back to a connected mode for receiving data and/or signals (e.g., reference signals) based on a request from the UE, or in response to data or signaling being scheduled for transmission to the UE. Moving the UE back into the connected mode may involve transmission of various random access and/or connection management communications between the UE and/or one or more network nodes. However, a UE in an inactive state may be permitted to transmit some relatively small and infrequent communications (e.g., data or signals) without first undergoing a state transition to the connected mode. In some aspects, the network may have performed a handover procedure prior to receiving a small data transmission (SDT) communication from the UE such that the currently-serving network node does not have contextual information for receiving and/or decoding communications from the UE.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to an aspect of the present disclosure, a user equipment (UE) comprises: one or more memory devices; and one or more processors in communication with the one or more memory devices, wherein the UE is configured to: receive, at a buffer for uplink (UL) transmissions, UL data associated with a first logical channel of a plurality of logical channels; transmit, to a network unit and based on a common UL data resource pool, the UL data, wherein the UE is configured to transmit the UL data based on a UL data transmission configuration, and wherein the UL data transmission configuration indicates that the first logical channel is configured for transmission using the common UL data resource pool.

According to an aspect of the present disclosure, a method of wireless communication performed by a user equipment (UE) comprises: receiving, at a buffer for uplink (UL) transmissions, UL data associated with a first logical channel of a plurality of logical channels; transmitting, to a network unit and based on a common UL data resource pool, the UL data, wherein the transmitting the UL data is based on a UL data transmission configuration, and wherein the UL data transmission configuration indicates that the first logical channel is configured for transmission using the common UL data resource pool.

According to another aspect of the present disclosure, a user equipment (UE) comprises: means for receiving, at a buffer for uplink (UL) transmissions, UL data associated with a first logical channel of a plurality of logical channels; means for transmitting, to a network unit and based on a common UL data resource pool, the UL data, wherein the means for transmitting the UL data is based on a UL data transmission configuration, and wherein the UL data transmission configuration indicates that the first logical channel is configured for transmission using the common UL data resource pool.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1A illustrates a wireless communication network according to some aspects of the present disclosure.

FIG. 1B illustrates an example disaggregated base station architecture according to some aspects of the present disclosure.

FIG. 2 illustrates a radio frame structure according to some aspects of the present disclosure.

FIG. 3A illustrates a method of wireless communication, according to some aspects of the present disclosure.

FIG. 3B is a diagrammatic view of a connectionless UL data transmission configuration, according to some aspects of the present disclosure.

FIG. 4 is a block diagram of a user equipment (UE) according to some aspects of the present disclosure.

FIG. 5 is a block diagram of an exemplary network unit according to some aspects of the present disclosure.

FIG. 6 is a flow diagram of a communication method according to some aspects of the present disclosure.

FIG. 7 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ~1M nodes/km²), ultra-low complexity (e.g., ~10s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

As explained above, a UE may be configured to transition to and from a plurality of connection modes or states. In this regard, if a UE is not scheduled to receive and/or transmit communications for a period of time, the network may cause the UE to transition into an idle state or an inactive state. Moving the UE to the idle or inactive state may conserve power and network resources. When the network receives data or signals in a buffer to transmit to the UE, the network may transmit one or more paging messages to initiate a transition of the UE to a connected mode. The mechanisms for transitioning the UE to different connection modes or states may be referred to as connection management. The protocols used by the connection management mechanisms may be referred to as random access procedures or protocols. In some examples, a random access procedure may be a four-step random access procedure. For example, the UE may transmit a random access preamble and the network may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE may transmit a connection request to the BS and the BS may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE may transmit a random access preamble and a connection request in a single transmission and the BS may respond by transmitting a random access response and a connection response in a single transmission.

In some instances, the UE and/or the network may be configured to communicate some small and/or infrequent communications while the UE is in an inactive mode such that the UE may receive or transmit the communication before being transitioned into a connected mode. The permitted communications may be referred to as small data transmission (SDT) communications. For instance, some applications like low-power Internet of Things (IoT) devices, industrial applications, and extended reality (XR) may have different demands than enhanced mobile broadband (eMBB) devices streaming data at a high bit-rate. One way to address the demands and limitations of these different applications is by applying a combination of connection-based and connectionless communications protocols. As explained above, in a connection-based communication model, the user equipment UE and the BS establish a dedicated link before data transfer. This often involves signaling procedures that transition the UE from an idle or inactive state to a connected state, with the network allocating radio resources for the duration of the session. Such an approach ensures reliable and predictable data delivery, which is advantageous for applications requiring continuous or large data transfers, such as streaming media and other latency-sensitive services.

However, connection-based communications can be less efficient for scenarios in which devices only send small, infrequent bursts of data. Many IoT applications, industrial wireless systems, and extended reality (XR) devices operate with stringent power constraints and sporadic transmission patterns. In such cases, the overhead associated with establishing and maintaining a persistent connection may unnecessarily consume network resources and drain the battery of the UE. Connectionless communications offer an alternative, allowing UEs to transmit data without fully transitioning into a dedicated connected state. This mode can reduce the amount of signaling required for each transmission, thereby providing a more energy-efficient communication mechanism for devices that do not need continuous or large-scale data exchange.

Small data transmission (SDT) protocols accommodate some of the demands of IoT, XR, and similar applications for a connectionless mode of data transmission. SDT focuses on enabling brief, low-volume messages to be sent and received with minimal overhead. By streamlining the signaling and resource reservation processes, SDT allows UEs to transmit their data quickly and return to an idle or low-power state promptly, thereby prolonging battery life. This approach is particularly beneficial for many IoT devices that periodically send sensor readings, status updates, or other short messages. In addition, industrial environments with numerous sensors or actuators can leverage SDT to ensure that large numbers of devices share network resources efficiently without overwhelming the signaling capabilities of the network.

SDT communications may include data, signals, or a combination thereof. SDT communications may include UL communications and DL communications. In a two-step RACH procedure, if a UL receives UL SDT data and/or a SDT UL signal in a buffer, the UE may transmit a random access communication including the SDT data and or SDT signal to a receiving BS or network node. In some aspects, the random access communication may comprise a connection request message. In some aspects, the connection request message may be or include a RRC Resume Request message. In another aspect, the random access communication may comprise a RACH preamble and the RRC Resume Request message.

Accordingly, connectionless communications between a UE and a network device (e.g., BS, radio unit (RU), etc.) can be facilitated in a number of different ways, including by allocating periodic or semi-periodic resources for UL transmissions. In some instances, a configured grant (CG) approach may be used in which a UE, or multiple UEs, are configured with a periodic or semi-static set of resources for UL transmissions. The CG resources may be connectionless such that the UL transmissions can be made without having to perform a connection procedure to move from an idle mode into a connected mode. In other cases, a UE may use a dynamic UL scheduling procedure. In this case, after receiving data in a UL buffer, the UE sends a scheduling request at an appropriate time, and wait for the network to send a buffer status report request with a dynamic grant (DG) for UL transmission resources. However, in both cases, there may be considerable delays between the time in which the UE receives UL data in a buffer, and the time the UE is able to transmit the UL data to the network. For instance, CG resources may be somewhat sparse, such that the UE waits a significant amount of time for the next CG resource. Further, dynamic grants involve multiple communications in both directions, even though the UL resources are dynamically granted, there can be similar latency and delays for dynamic UL grants.

In some cases, such as XR, it may be desirable to provide for connectionless UL data transmissions that have reduced latency compared to the CG and DG approaches explained above. One approach to achieve these goals is by provisioning a resource pool for a set of UEs for UL small packet transmissions. Resource pools can provide sufficient resources such that the delay involved with sending UL transmissions that arrive in the UE's buffer is reduced compared to CG. Resource pool transmissions may be contention based, which involves some risk or chance of collisions. The resource pools for connectionless UL transmissions may advantageously provide for UL transmissions having a variety of payload sizes. The ability to make connectionless UL transmissions that have unpredictable buffer arrival times and variable payload sizes make connectionless resource pools a suitable choice for some applications, like XR.

However, configuring resource pools in this way can use a significant amount of available time and frequency resources. Further, the more UL transmissions that are made using connectionless resource pools, the higher the probability of collisions, which can increase overhead, power consumption, and create additional latency that the resource pools are intended to avoid. Accordingly, it is beneficial to limit the UL transmissions that are made using connectionless resource pools.

According to aspects of the present disclosure, a UE and network are configured to configure, manage, or otherwise determine to use a connectionless UL resource pool, or another connectionless or connection-based set of resources (e.g., CG, DG) based on the logical channel(s) associated with the UL communication to be transmitted.

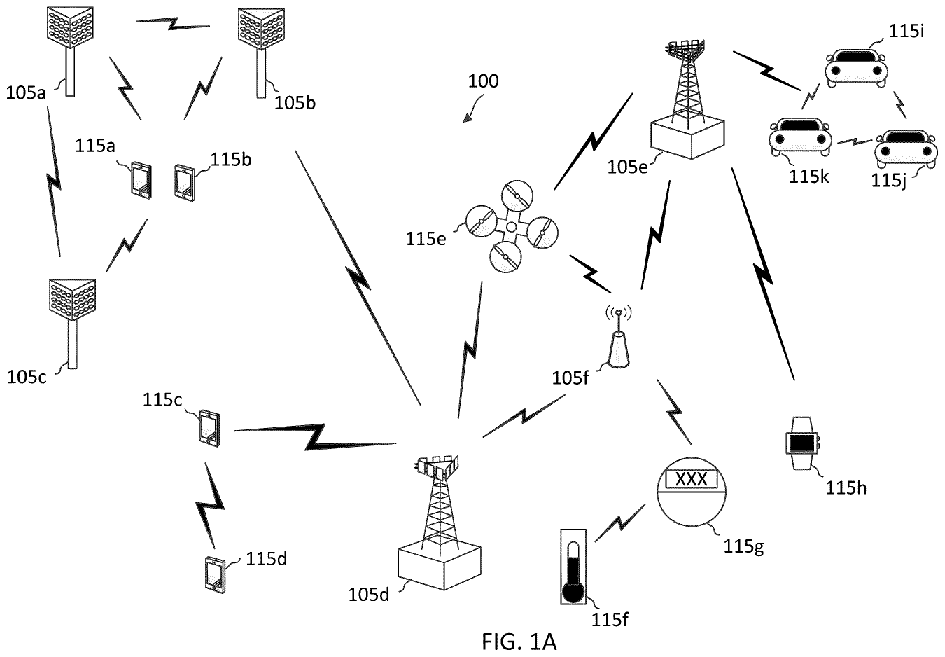

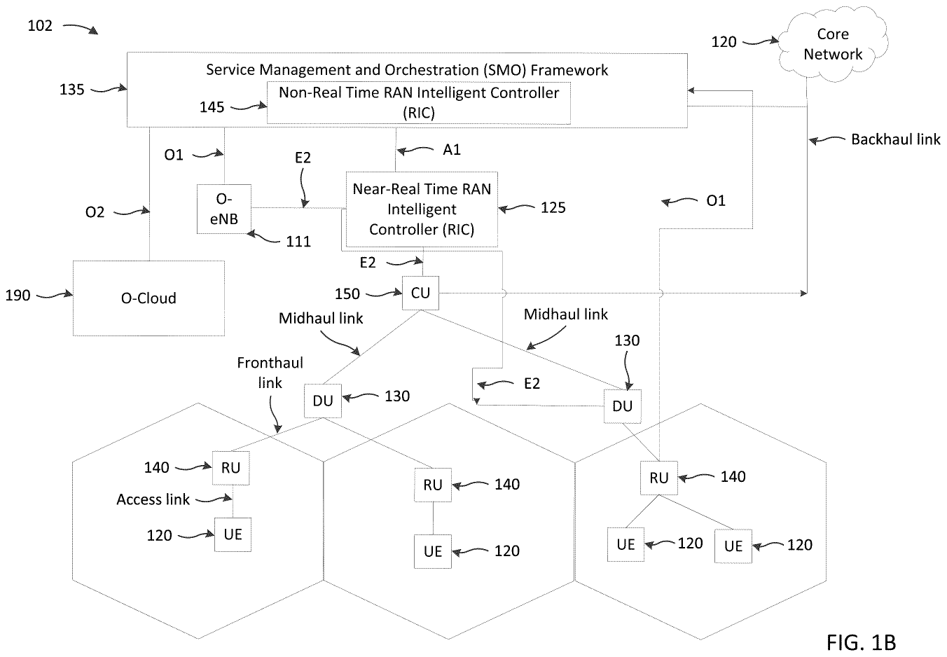

FIG. 1A illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1A, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1A, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything(V2X), cellular-V2X (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network. The BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel.

In some aspects, the network 100 may operate over a high frequency band, for example, in a frequency range 1 (FR1) band or a frequency range 2 (FR2) band. FR1 may refer to frequencies in the sub-6 GHz range and FR2 may refer to frequencies in the mmWave range. To overcome the high path-loss at high frequency, the BSs 105 and the UEs 115 may communicate with each other using directional beams. For instance, a BS 105 may transmit SSBs by sweeping across a set of predefined beam directions and may repeat the SSB transmissions at a certain time interval in the set of beam directions to allow a UE 115 to perform initial network access. In some instances, each beam and its corresponding characteristics may be identified by a beam index. For instance, each SSB may include an indication of a beam index corresponding to the beam used for the SSB transmission. The UE 115 may determine signal measurements, such as reference signal received power (RSRP) and/or reference signal received quality (RSRQ), for the SSBs at the different beam directions and select a best DL beam. The UE 115 may indicate the selection by transmitting a PRACH signal (e.g., MSG1) using PRACH resources associated with the selected beam direction. For instance, the SSB transmitted in a particular beam direction may indicate PRACH resources that may be used by a UE 115 to communicate with the BS 105 in that particular beam direction. After selecting the best DL beam, the UE 115 may complete the random access procedure (e.g., the 4-step random access or the 2-step random access) and proceed with network registration and normal operation data exchange with the BS 105. In some instances, the initially selected beams may not be optimal or the channel condition may change, and thus the BS 105 and the UE 115 may perform a beam refinement procedure to refine a beam selection. For instance, BS 105 may transmit CSI-RSs by sweeping narrower beams over a narrower angular range and the UE 115 may report the best DL beam to the BS 105. When the BS 105 uses a narrower beam for transmission, the BS 105 may apply a higher gain, and thus may provide a better performance (e.g., a higher signal-noise-ratio (SNR)). In some instances, the channel condition may degrade and/or the UE 115 may move out of a coverage of an initially selected beam, and thus the UE 115 may detect a beam failure condition. Upon detecting a beam failure, the UE 115 may perform a BFR with the BS 105 to request for communication over a different beam direction.

In some aspects, the network 100 may be an IoT network and the UEs 115 may be IoT nodes, such as smart printers, monitors, gaming nodes, cameras, audio-video (AV) production equipment, industrial IoT devices, and/or the like. The transmission payload data size of an IoT node typically may be relatively small, for example, in the order of tens of bytes. In some aspects, the network 100 may be a massive IoT network serving tens of thousands of nodes (e.g., UEs 115) over a high frequency band, such as a FR1 band or a FR2 band. Mechanisms for performing beamforming and beam management in a massive IoT network or any network with a massive number of nodes (e.g., UEs 115) are described in greater detail herein.

FIG. 1B shows a diagram illustrating an example disaggregated base station 102 architecture. The disaggregated base station 102 architecture may include one or more central units (CUs) 150 that can communicate directly with a core network 104 via a backhaul link, or indirectly with the core network 104 through one or more disaggregated base station units (such as a Near-Real Time (Near-RT) RAN Intelligent Controller (RIC) 125 via an E2 link, or a Non-Real Time (Non-RT) RIC 145 associated with a Service Management and Orchestration (SMO) Framework 135, or both). A CU 150 may communicate with one or more distributed units (DUs) 130 via respective midhaul links, such as an F1 interface. The DUs 130 may communicate with one or more radio units (RUs) 140 via respective fronthaul links. The RUs 140 may communicate with respective UEs 120 via one or more radio frequency (RF) access links. In some implementations, the UE 120 may be simultaneously served by multiple RUs 140.

Each of the units, i.e., the CUs 150, the DUs 130, the RUs 140, as well as the Near-RT RICs 125, the Non-RT RICs 145 and the SMO Framework 135, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 150 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 150. The CU 150 may be configured to handle user plane functionality (i.e., Central Unit-User Plane (CU-UP)), control plane functionality (i.e., Central Unit-Control Plane (CU-CP)), or a combination thereof. In some implementations, the CU 150 can be logically split into one or more CU-UP units and one or more CU-CP units. The CU-UP unit can communicate bidirectionally with the CU-CP unit via an interface, such as the E1 interface when implemented in an O-RAN configuration. The CU 150 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 130 may further host one or more low PHY layers. Each layer (or module) can be implemented with an interface configured to communicate signals with other layers (and modules) hosted by the DU 130, or with the control functions hosted by the CU 150.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs. In some implementations, real-time and non-real-time aspects of control and user plane communication with the RU(s) 140 can be controlled by the corresponding DU 130. In some scenarios, this configuration can enable the DU(s) 130 and the CU 150 to be implemented in a cloud-based RAN architecture, such as a vRAN architecture.

The SMO Framework 135 may be configured to support RAN deployment and provisioning of non-virtualized and virtualized network elements. For non-virtualized network elements, the SMO Framework 135 may be configured to support the deployment of dedicated physical resources for RAN coverage requirements which may be managed via an operations and maintenance interface (such as an O1 interface). For virtualized network elements, the SMO Framework 135 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 150, DUs 130, RUs 140 and Near-RT RICs 125. In some implementations, the SMO Framework 135 can communicate with a hardware aspect of a 4G RAN, such as an open eNB (O-eNB) 111, via an O1 interface. Additionally, in some implementations, the SMO Framework 135 can communicate directly with one or more RUs 140 via an O1 interface. The SMO Framework 135 also may include a Non-RT RIC 145 configured to support functionality of the SMO Framework 135.

The Non-RT RIC 145 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 145 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 150, one or more DUs 130, or both, as well as an O-eNB, with the Near-RT RIC 125.

In some implementations, to generate AI/ML models to be deployed in the Near-RT RIC 125, the Non-RT RIC 145 may receive parameters or external enrichment information from external servers. Such information may be utilized by the Near-RT RIC 125 and may be received at the SMO Framework 135 or the Non-RT RIC 145 from non-network data sources or from network functions. In some examples, the Non-RT RIC 145 or the Near-RT RIC 125 may be configured to tune RAN behavior or performance. For example, the Non-RT RIC 145 may monitor long-term trends and patterns for performance and employ AI/ML models to perform corrective actions through the SMO Framework 135 (such as reconfiguration via O1) or via creation of RAN management policies (such as A1 policies).

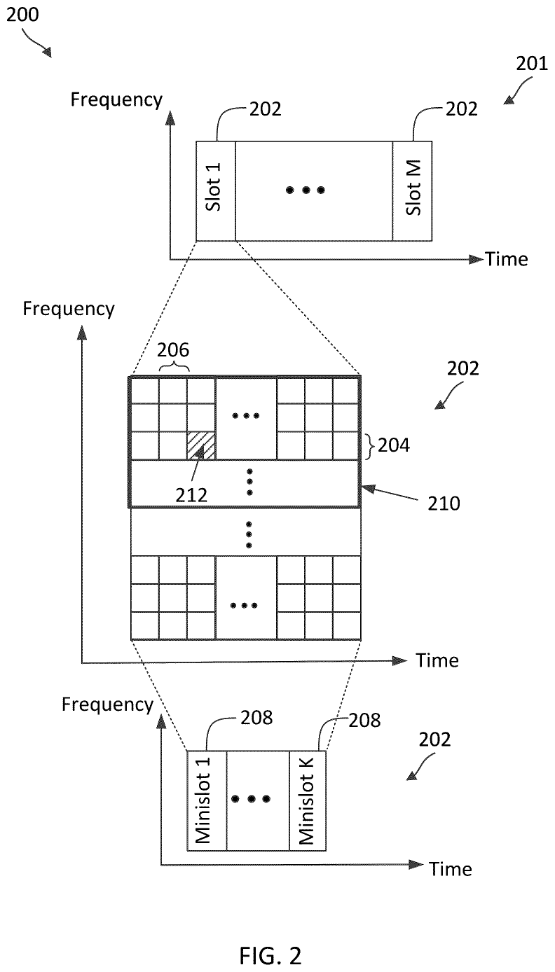

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The radio frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1A) may schedule a UE (e.g., UE 115 in FIG. 1A) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N-1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

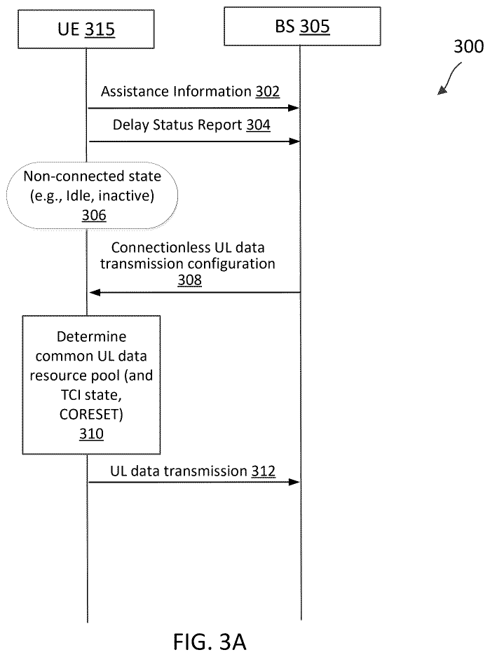

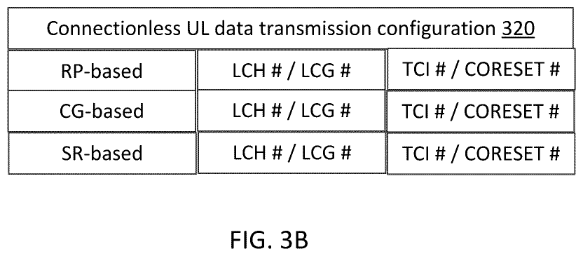

FIG. 3A is a signaling diagram illustrating a wireless communication method 300, according to aspects of the present disclosure. The method 300 is performed by a UE 315 and a BS 305. However, it will be understood that the BS 305 may represent, or be substituted by, any suitable network entity or node. For instance, the BS 305 may comprise one or more units of a disaggregated BS in an O-RAN network. In some aspects, the BS 305 may be BSs 105 of the network 100 and/or the network unit 500. In this regard, the BS 305 include the network unit 500, including the processor 502, memory 504, Connectionless UL data transmission module 508, transceiver 510, and/or the antennas 516. Further, the UE 315 may be one of the UEs 115 of the network 100 and/or the UE 400. In this regard, the UE 315 may comprise the processor 402, memory 404, Connectionless UL data transmission module 408, transceiver 410, and/or the antennas 416.

As will be further described below, the method includes signaling and configurations for performing UL data transmissions while the UE 315 is in a connectionless, or non-connected state. For instance, according to the method 300, the UE 315 may perform a UL data transmission while in an Idle state, an inactive state, or any other suitable non-connected state. The non-connected state may refer to an RRC connection state with the network. In the non-connected state, the UE 315 may be in a reduced state of synchronization with the network, and may have reduced monitoring and signaling functions to conserve power. The UE 315 may be configured to transmit UL data having certain characteristics, such as being relatively small in size such as a scheduling request or BSR or UCI. In this regard, the UL data transmission may be similar or identical to a small data transmission (SDT). In some aspects, the UE 315 may be configured to perform the UL data transmission using a procedure similar or identical to a 2-step RACH procedure. In some aspects, the UL data for connectionless transmission may have a variable size.

The method 300 includes mechanisms for determining whether to transmit the UL data using preconfigured common UL data resource pools for connectionless UL transmissions. The network may allocate one or more common UL transmission resource pools for connectionless transmission. Further, the network may configure other resources for connectionless UL data transmission, including configured grant (CG) resources. The network may also provide mechanisms for the UE to perform UL data transmissions using dynamic grant (DG) resources by sending a scheduling request and receiving a grant of resources. In some aspects, the resource pool-based connectionless transmissions may advantageously facilitate low-latency UL transmissions with variable packet sizes. However, it may be desirable to provision the common resource pools to a subset of connectionless UL transmissions that meet certain criteria. In the method 300, the UE 315 determines whether to use a common UL data resource pool for a connectionless UL data transmission based on a common UL data resource pool configuration.

At action 302, the UE 315 transmits, to the BS 305, assistance information. The assistance information may indicate, or otherwise be associated with, one or more logical channels or logical channel groups. In some aspects, the assistance information may indicate one or more logical channels (or one or more logical channel groups) that the UE 315 prefers for common UL data resource pool transmissions. In some aspects, the UE 315 determines the one or more logical channels or logical channel groups based on criteria provided by the network. For example, the network may provide a RRC configuration indicating at least one of a maximum number of logical channels for transmission using the common UL data resource pool, or a minimum number of logical channels for transmission using the common UL data resource pool. The indication can be in the form of logical channel group ID, a bitmap, or any other suitable type of indication.. The UE 315 may determine a set of one or more logical channels or logical channel groups based on the maximum or minimum numbers provided by the network.

At action 304, the UE 315 transmits, to the BS 305, a delay status report (DSR). The DSR may indicate one or more delay-related values for one or more logical channels, or for one or more logical channel groups. In some aspects, the delay-related values may information related to how long data has been queued for transmission. The DSR may indicate delay information specific to one or more logical channels. For instance, the DSR may indicate delay values for each of one or more logical channels, or logical channel groups.

At action 306, the UE enters a non-connected state, or connectionless state. As explained above, a non-connected state may include an idle state, an inactive state, or any other suitable state. The non-connected state may refer to an RRC connection state. In some aspects, action 306 may be performed before action 304, before action 302, or both. In some aspects, the UE in the non-connected state may be camped on a cell, or on the network, but is not actively exchanging user data. The UE in the non-connected state may have reduced network synchronization, monitoring, and reference signaling compared to a connected state (e.g., RRC_CONNECTED). For instance, in a non-connected state (e.g., Idle, Inactive), the UE may monitor for broadcast signals and information and SSBs to obtain some amount of synchronization, and may monitor for paging signals, but may not monitor for (or may monitor less frequently for) precision synchronization or tracking reference signals, like CSI-RS or cell-specific reference signals.

At action 308, the UE 315 receives, from the BS 305, a connectionless UL data transmission configuration. In some aspects, the autonomous connectionless UL data transmission configuration comprises or indicates a list of one or more logical channels, or logical channel groups, which are configured for connectionless UL transmission using one or more of the common UL data resource pools. In some aspects, the connectionless UL data transmission may be based on non-orthogonal multiple access (NOMA), RACH, or another other suitable connectionless procedure for accessing shared resources to transmit data. In some aspects, the connectionless UL data transmission configuration includes a listing of a plurality of logical channels or logical channel groups and indicates which type of connectionless transmission resource (or resources) are allowed to use. For instance, the connectionless UL data transmission configuration may indicate whether a given logical channel or logical channel group may be transmitted using a common UL data resource pool, CG resources, or DG resources.

In other aspects, the connectionless UL data transmission configuration may indicate which types of physical channels or information elements may be transmitted using the common UL data resource pools. In some aspects, the connectionless UL data transmission configuration is based on the assistance information transmitted at action 302, the DSR transmitted at action 304, or both. the connectionless UL data transmission configuration indicates a plurality of common UL data resource pools, the plurality of common UL data resource pools comprising the common UL data resource pool, wherein each of the plurality of common UL data resource pools is associated with one or more transmission reception points (TRPs) of a plurality of TRPs. In some aspects, the plurality of TRPs is associated with a corresponding plurality of transmission configuration indicator (TCI) states, wherein the connectionless UL data transmission configuration indicates, for each of the common UL data resource pools, one or more TCI states which can be used for UL transmissions.

In some aspects, the connectionless UL data transmission configuration indicates: a plurality of common UL data resource pools, the plurality of common UL data resource pools comprising the common UL data resource pool; and for each of the common UL data resource pools, one or more control resource sets (CORESETS) which can be used for UL transmissions. In some aspects, the connectionless UL data transmission configuration indicates at least one of: a set of one or more physical channels that can be transmitted using the common UL data resource pool; or a set of one or more MAC-control element (CE) types that can be transmitted using the common UL data resource pool.

FIG. 3B is a diagram illustrating a connectionless UL data transmission configuration 320 according to aspects of the present disclosure, consistent with the description above. For instance, the connectionless UL data transmission configuration 320 indicates a list of one or more logical channels or logical channel groups. The configuration 320 further indicates whether the logical channels or groups are configured to, or allowed to, be transmitted using the common UL data resource pools, CG resources, or DG resources. The configuration 320 may further indicate other parameters or limitations for the connectionless UL transmissions, such as one or more TCI states that can be used for transmitting a given logical channel or group, one or more CORESETS that can be used for transmitting a given logical channel or group, or a combination thereof. In some aspects, the configuration is updated by the network based on information provide by the UE 315. In some aspects, the configuration 320 indicates criteria or parameters that the UE 315 may use to determine which logical channels or groups may be transmitted using the common UL data resource pools.

At action 310, the UE determines one or more common UL data resource pools to transmit a UL data. The UE may determine the one or more common UL data resource pools to transmit based on the connectionless UL data transmission configuration described above (e.g., the configuration 320).

At action 312, the UE transmits a UL data transmission using the common UL data resource pools based on the connectionless UL transmission configuration. In some aspects, the UL data transmission comprises an SDT, or a similar UL data transmission meeting certain size and data criteria for connectionless transmission.

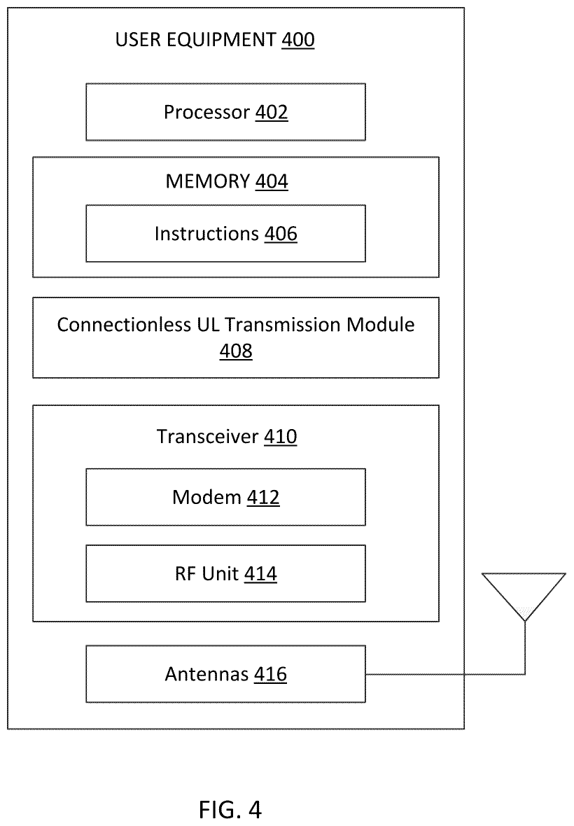

FIG. 4 is a block diagram of an exemplary UE 400 according to some aspects of the present disclosure. The UE 400 may be a UE 115 discussed above in FIG. 1A or a UE 315 discussed above in FIGS. 3A-3F. As shown, the UE 400 may include a processor 402, a memory 404, a Connectionless UL data transmission module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with aspects of the present disclosure, for example, aspects of FIGS. 3A-3B. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The Connectionless UL data transmission module 408 may be implemented via hardware, software, or combinations thereof. For example, the Connectionless UL data transmission module 408 may be implemented as a processor, circuit, and/or instructions 406 stored in the memory 404 and executed by the processor 402. In some instances, the Connectionless UL data transmission module 408 can be integrated within the modem subsystem 412. For example, the Connectionless UL data transmission module 408 can be implemented by a combination of software components (e.g., executed by a DSP or a general processor) and hardware components (e.g., logic gates and circuitry) within the modem subsystem 412.

The Connectionless UL data transmission module 408 may be used for various aspects of the present disclosure, for example, aspects of aspects of FIGS. 3A-3B.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404 and/or the Connectionless UL data transmission module 408 according to a modulation and coding scheme (MCS), e.g., a low-density parity check (LDPC) coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., PUCCH control information, PRACH signals, PUSCH data, SDT data, non-SDT data, reference signals, RRC messages, etc.) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., SSBs, PDCCH, PDSCH, RRC messages, SDT data, SDT signals, etc.) to the Connectionless UL data transmission module 408 for processing. The antennas 416 may include multiple antennas of similar or different designs in order to sustain multiple transmission links. The RF unit 414 may configure the antennas 416.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

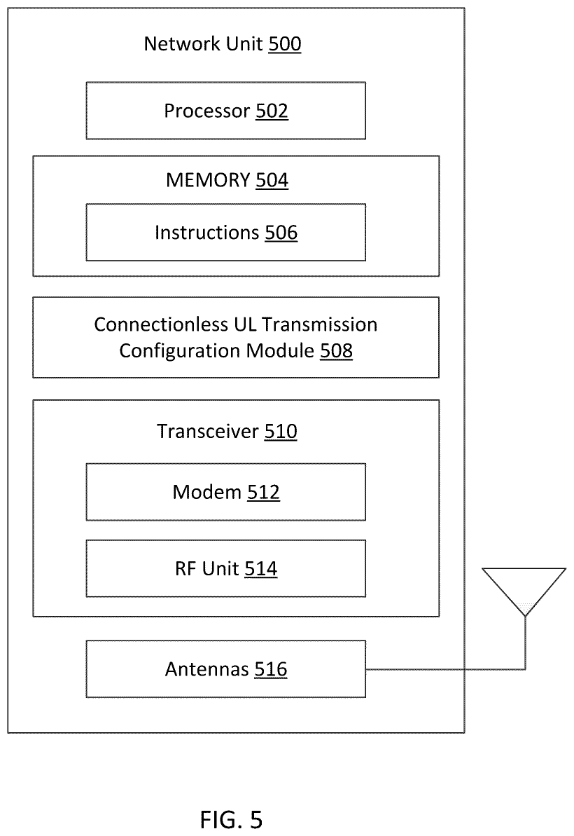

FIG. 5 is a block diagram of an exemplary network node 500 according to some aspects of the present disclosure. The network node 500 may be a BS 105 in the network 100 as discussed above in FIG. 1A or a network node 305 discussed above in FIGS. 3A-3F. A shown, the network node 500 may include a processor 502, a memory 504, a connectionless UL data transmission module 508, a transceiver 510 including a modem subsystem 512 and a RF unit 514, and one or more antennas 516. These elements may be in direct or indirect communication with each other, for example via one or more buses. It will be understood that the network node 500 shown in FIG. 5 may be a BS and/or any other suitable type of network node or network unit. For example, the network node 500 may include an aggregated BS or a disaggregated BS, as described above with respect to FIG. 1AB.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 3A-3B. Instructions 506 may also be referred to as code, which may be interpreted broadly to include any type of computer-readable statement(s) as discussed above with respect to FIG. 4.

The Connectionless UL data transmission module 508 may be implemented via hardware, software, or combinations thereof. For example, the Connectionless UL data transmission module 508 may be implemented as a processor, circuit, and/or instructions 506 stored in the memory 504 and executed by the processor 502. In some instances, the Connectionless UL data transmission module 508 can be integrated within the modem subsystem 512. For example, the Connectionless UL data transmission module 508 can be implemented by a combination of software components (e.g., executed by a DSP or a general processor) and hardware components (e.g., logic gates and circuitry) within the modem subsystem 512.

The Connectionless UL data transmission module 508 may be used for various aspects of the present disclosure, for example, aspects of aspects of FIGS. 3A-3B.

As shown, the transceiver 510 may include the modem subsystem 512 and the RF unit 514. The transceiver 510 can be configured to communicate bi-directionally with other devices, such as the UEs 115 and/or 300 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., SSBs, RMSI, MIB, SIB, FBE configuration, PRACH configuration PDCCH, PDSCH) from the modem subsystem 512 (on outbound transmissions) or of transmissions originating from another source such as a UE 115, the UE 315, and/or UE 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped UE 115 or 215 according to some aspects of the present disclosure. The antennas 516 may further receive data messages transmitted from other devices and provide the received data messages for processing and/or demodulation at the transceiver 510. The transceiver 510 may provide the demodulated and decoded data (e.g., PUCCH control information, PRACH signals, PUSCH data) to the Connectionless UL data transmission module 508 for processing. The antennas 516 may include multiple antennas of similar or different designs in order to sustain multiple transmission links.

In an example, the transceiver 510 is configured to transmit, to a UE, system information including an FBE configuration indicating a plurality of frame periods, each including a gap period for contention at the beginning of the frame period, and communicate with the UE based on the FBE configuration, for example, by coordinating with the Connectionless UL data transmission module 508.

In an aspect, the network node 500 can include multiple transceivers 510 implementing different RATs (e.g., NR and LTE). In an aspect, the network node 500 can include a single transceiver 510 implementing multiple RATs (e.g., NR and LTE). In an aspect, the transceiver 510 can include various components, where different combinations of components can implement different RATs.

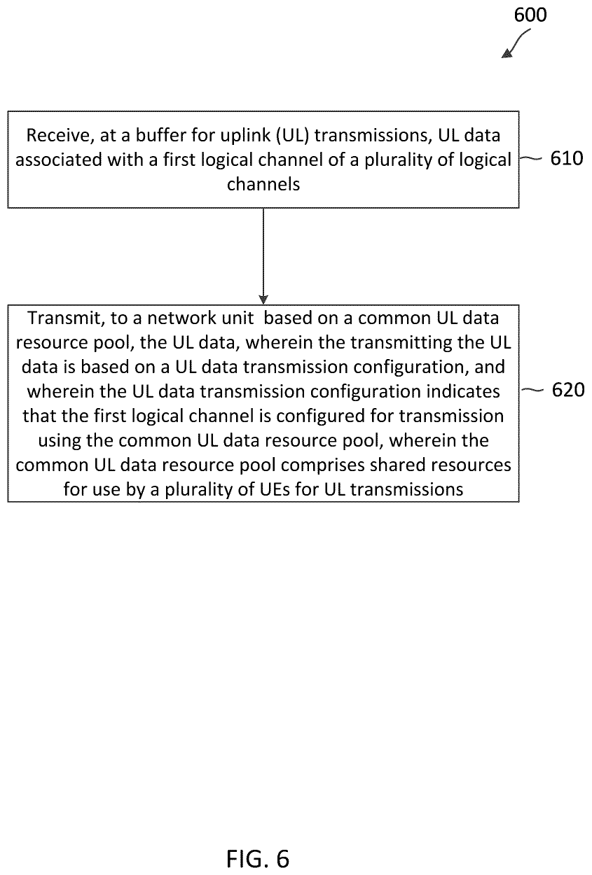

FIG. 6 is a flow diagram of a communication method 600 according to some aspects of the present disclosure. Steps of the method 600 can be executed by a computing device (e.g., a processor, processing circuit, and/or other suitable component) of an apparatus or other suitable means for performing the steps. For example, a network node, such as one of the BSs 105, the network nodes 305, and/or the network node 500, may utilize one or more components, such as the processor 502, the memory 504, the Connectionless UL data transmission module 508, the transceiver 510, and the one or more antennas 516, to execute the steps of method 600. The method 600 may employ similar mechanisms as in the method 300 described above with respect to FIG. 3A. As illustrated, the method 600 includes a number of enumerated steps, but aspects of the method 600 may include additional steps before, after, and in between the enumerated steps. In some aspects, one or more of the enumerated steps may be omitted or performed in a different order.

At block 610, the UE receives, at a buffer for uplink (UL) transmissions, UL data associated with a first logical channel of a plurality of logical channels. In some aspects, the UL data may comprise UL user data or control data. The UL data may correspond to a logical channel or channel group, and a physical channel. For instance, the UL data may be configured for transmission using a PUCCH, a PUSCH, or any other suitable type of UL channel. In some aspects, the UL data may meet one or more criteria for connectionless transmission. For instance, the UL data may have a size that falls below a threshold (e.g., SDT).

At block 620, the UE transmits, to a network unit and based on a common UL data resource pool, the UL data. In some aspects, the transmitting the UL data is based on a connectionless UL data transmission configuration, and the connectionless UL data transmission configuration indicates that the first logical channel is configured for transmission using the common UL data resource pool. In some aspects, the UL data is transmitted while in a non-connected state. In some aspects, the common UL data resource pool comprises shared resources for use by a plurality of UEs for UL transmissions.

In some aspects, the method further comprises the UE receive, from the network unit, one or more configurations, wherein the one or more configurations comprise one or more of: a configuration of common resource pool for UL transmission; a logical channel configuration; a list of logical channels configured for the common UL data resource pool; or a list of logical channel groups configured for the common UL data resource pool, wherein the connectionless UL data transmission configuration is based on the one or more configurations. In some aspects, the connectionless UL data transmission configuration indicates that a second logical channel is configured for transmission using configured grant (CG) resources. In some aspects, the connectionless UL data transmission configuration indicates that a third logical channel is configured for transmission using dynamic grant (DG) resources associated with a scheduling request (SR).

In some aspects, the UE transmits the UL data based on the logical channel configuration, wherein the logical channel configuration comprises the connectionless UL data transmission configuration. In some aspects, the UL data is associated with a medium access control (MAC) physical data unit (PDU) type, and wherein the connectionless UL data transmission configuration indicates that the MAC PDU type is configured for transmission using the common UL data resource pool. In some aspects, the method further comprises transmitting, to the network unit, assistance information indicating one or more logical channels, wherein the one or more configurations are based on the assistance information. In some aspects, the assistance information indicates that the first logical channel is preferred for transmission using the common UL data resource pool. In some aspects, the one or more logical channels are selected based on at least one of a maximum number of logical channels for transmission using the common UL data resource pool, or a minimum number of logical channels for transmission using the common UL data resource pool.

In some aspects, the method 600 further comprises: transmitting, to the network unit, a delay status report, indicating one or more delay values for one or more logical channels, including the first logical channel, wherein the connectionless UL data transmission configuration is based on the delay status report.

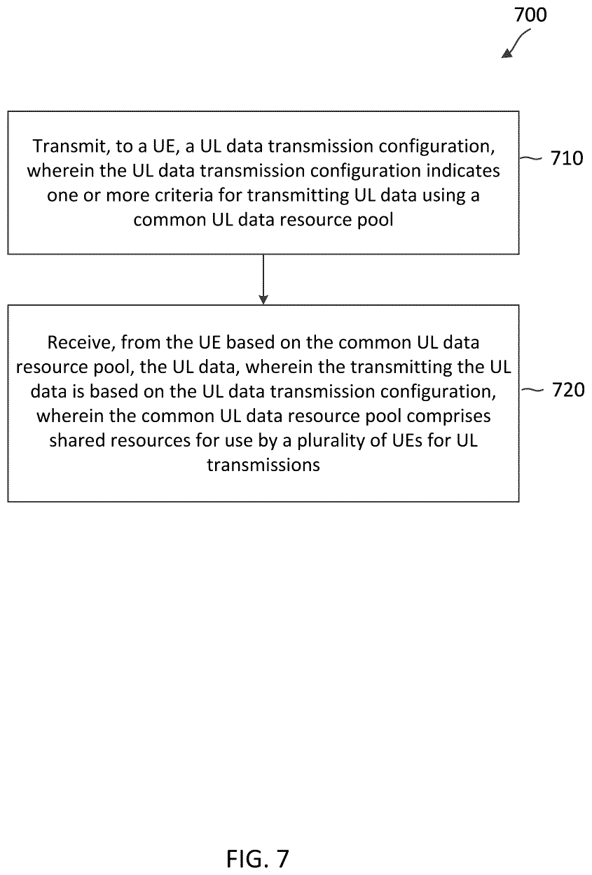

FIG. 7 is a flow diagram of a communication method 700 according to some aspects of the present disclosure. Steps of the method 700 can be executed by a computing device (e.g., a processor, processing circuit, and/or other suitable component) of an apparatus or other suitable means for performing the steps. For example, a network node, such as one of the BSs 105, the network nodes 305, and/or the network node 500, may utilize one or more components, such as the processor 502, the memory 504, the Connectionless UL data transmission module 508, the transceiver 510, and the one or more antennas 516, to execute the steps of method 700. The method 700 may employ similar mechanisms as in the method 300 described above with respect to FIG. 3A. As illustrated, the method 700 includes a number of enumerated steps, but aspects of the method 700 may include additional steps before, after, and in between the enumerated steps. In some aspects, one or more of the enumerated steps may be omitted or performed in a different order.

Block 710 comprises transmitting, to a UE, a connectionless UL data transmission configuration, wherein the connectionless UL data transmission configuration indicates one or more criteria for transmitting UL data while in a non-connected state using a common UL data resource pool.

Block 720 comprises receiving, from the UE operating in the non-connected state and based on the common UL data resource pool, the UL data, wherein the transmitting the UL data is based on the connectionless UL data transmission configuration. In some aspects, the common UL data resource pool comprises shared resources for use by a plurality of UEs for UL transmissions.

In some aspects, the method 700 further comprises transmitting, to the UE, one or more configurations, wherein the one or more configurations comprise one or more of: a configuration of common resource pool for UL transmission; a logical channel configuration; a list of logical channels configured for the common UL data resource pool; or a list of logical channel groups configured for the common UL data resource pool, wherein the connectionless UL data transmission configuration is based on the one or more configurations. In some aspects, the connectionless UL data transmission configuration indicates that a second logical channel is configured for transmission using configured grant (CG) resources. In some aspects, the connectionless UL data transmission configuration indicates that a third logical channel is configured for transmission using dynamic grant (DG) resources associated with a scheduling request (SR).

In some aspects, the transmitting the one or more configurations comprises transmitting the logical channel configuration, wherein the receiving is based on the logical channel configuration, and wherein the logical channel configuration comprises the connectionless UL data transmission configuration. In some aspects, the UL data is associated with a medium access control (MAC) physical data unit (PDU) type, and wherein the connectionless UL data transmission configuration indicates that the MAC PDU type is configured for transmission using the common UL data resource pool. In some aspects, the method 700 further comprises receiving, from the UE, assistance information indicating one or more logical channels, wherein the one or more configurations are based on the assistance information. In some aspects, the assistance information indicates that the first logical channel is preferred for transmission using the common UL data resource pool.

In some aspects, the one or more logical channels are selected based on at least one of a maximum number of logical channels for transmission using the common UL data resource pool, or a minimum number of logical channels for transmission using the common UL data resource pool. In some aspects, the method 700 further comprises receiving, from the UE, a delay status report, indicating one or more delay values for one or more logical channels, including the first logical channel, wherein the connectionless UL data transmission configuration is based on the delay status report. In some aspects, the connectionless UL data transmission configuration indicates a plurality of common UL data resource pools, the plurality of common UL data resource pools comprising the common UL data resource pool, wherein each of the plurality of common UL data resource pools is associated with one or more transmission reception points (TRPs) of a plurality of TRPs.

In some aspects, the plurality of TRPs is associated with a corresponding plurality of transmission configuration indicator (TCI) states, wherein the connectionless UL data transmission configuration indicates, for each of the common UL data resource pools, one or more TCI states which can be used for UL transmissions. In some aspects, the connectionless UL data transmission configuration indicates: a plurality of common UL data resource pools, the plurality of common UL data resource pools comprising the common UL data resource pool; and for each of the common UL data resource pools, one or more control resource sets (CORESETS) which can be used for UL transmissions. In some aspects, the connectionless UL data transmission configuration indicates at least one of: a set of one or more physical channels that can be transmitted using the common UL data resource pool; or a set of one or more MAC-control element (CE) types that can be transmitted using the common UL data resource pool.

### EXEMPLARY ASPECTS OF THE DISCLOSURE

Aspect 1. A method of wireless communication performed by a user equipment (UE), the method comprising: receiving, at a buffer for uplink (UL) transmissions, UL data associated with a first logical channel of a plurality of logical channels; transmitting, to a network unit and based on a common UL data resource pool, the UL data, wherein the transmitting the UL data is based on a UL data transmission configuration, and wherein the UL data transmission configuration indicates that the first logical channel is configured for transmission using the common UL data resource pool, wherein the common UL data resource pool comprises shared resources for use by a plurality of UEs for UL transmissions.
Aspect 2. The method of aspect 1, wherein the transmitting the UL data comprises transmitting the UL data while in a non-connected state.
Aspect 3. The method of any of aspects 1-2, further comprising: receiving, from the network unit, one or more configurations, wherein the one or more configurations comprise one or more of: a configuration of common resource pool for UL transmission; a logical channel configuration; a list of logical channels configured for the common UL data resource pool; or a list of logical channel groups configured for the common UL data resource pool, wherein the UL data transmission configuration is based on the one or more configurations.
Aspect 4. The method of aspect 3, wherein the UL data transmission configuration indicates that a second logical channel is configured for transmission using configured grant (CG) resources.
Aspect 5. The method of any of aspects 3-4, wherein the UL data transmission configuration indicates that a third logical channel is configured for transmission using dynamic grant (DG) resources associated with a scheduling request (SR).
Aspect 6. The method of any of aspects 3-5, wherein the receiving the one or more configurations comprises receiving the logical channel configuration, wherein the transmitting is based on the logical channel configuration, and wherein the logical channel configuration comprises the UL data transmission configuration.
Aspect 7. The method of any of aspects 3-6, wherein the UL data is associated with a medium access control (MAC) physical data unit (PDU) type, and wherein the UL data transmission configuration indicates that the MAC PDU type is configured for transmission using the common UL data resource pool.
Aspect 8. The method of any of aspects 3-7, further comprising: transmitting, to the network unit, assistance information indicating one or more logical channels, wherein the one or more configurations are based on the assistance information.
Aspect 9. The method of aspect 8, wherein the assistance information indicates that the first logical channel is preferred for transmission using the common UL data resource pool.
Aspect 10. The method of any of aspects 8-9, wherein the one or more logical channels are selected based on at least one of a maximum number of logical channels for transmission using the common UL data resource pool, or a minimum number of logical channels for transmission using the common UL data resource pool.
Aspect 11. The method of any of aspects 1-10, further comprising: transmitting, to the network unit, a delay status report, indicating one or more delay values for one or more logical channels, including the first logical channel, wherein the UL data transmission configuration is based on the delay status report.
Aspect 12. The method of any of aspects 1-11, wherein the UL data transmission configuration indicates a plurality of common UL data resource pools, the plurality of common UL data resource pools comprising the common UL data resource pool, wherein each of the plurality of common UL data resource pools is associated with one or more transmission reception points (TRPs) of a plurality of TRPs.
Aspect 13. The method of aspect 12, wherein the plurality of TRPs is associated with a corresponding plurality of transmission configuration indicator (TCI) states, wherein the UL data transmission configuration indicates, for each of the common UL data resource pools, one or more TCI states which can be used for UL transmissions.
Aspect 14. The method of any of aspects 1-13, wherein the UL data transmission configuration indicates: a plurality of common UL data resource pools, the plurality of common UL data resource pools comprising the common UL data resource pool; and for each of the common UL data resource pools, one or more control resource sets (CORESETS) which can be used for UL transmissions.
Aspect 15. The method of any of aspects 1-14, wherein the UL data transmission configuration indicates at least one of: a set of one or more physical channels that can be transmitted using the common UL data resource pool; or a set of one or more MAC-control element (CE) types that can be transmitted using the common UL data resource pool.
Aspect 16, a user equipment (UE), comprising: one or more memory devices; and one or more processors in communication with the one or more memory devices, wherein the UE is configured to perform the steps of any of aspects 1-15.
Aspect 17, a non-transitory, computer-readable memory having program code recorded thereon, where the program code comprises instructions executable by one or more processors of a user equipment (UE) to cause the UE to perform the steps of any of aspects 1-15.
Aspect 18, a user equipment (UE), comprising: means for performing the steps of any of aspects 1-15.
Aspect 19. A method of wireless communication performed by a network unit, the method comprising: transmitting, to a UE, a UL data transmission configuration, wherein the UL data transmission configuration indicates one or more criteria for transmitting UL data while in a non-connected state using a common UL data resource pool; and receiving from the UE operating in the non-connected state and based on the common UL data resource pool, the UL data, wherein the transmitting the UL data is based on the UL data transmission configuration, wherein the common UL data resource pool comprises shared resources for use by a plurality of UEs for UL transmissions.
Aspect 21. The method of any of aspects 19-20, further comprising: transmitting, to the UE, one or more configurations, wherein the one or more configurations comprise one or more of: a configuration of common resource pool for UL transmission; a logical channel configuration; a list of logical channels configured for the common UL data resource pool; or a list of logical channel groups configured for the common UL data resource pool, wherein the UL data transmission configuration is based on the one or more configurations.
Aspect 22. The method of aspect 21, wherein the UL data transmission configuration indicates that a second logical channel is configured for transmission using configured grant (CG) resources.
Aspect 23. The method of any of aspects 21-22, wherein the UL data transmission configuration indicates that a third logical channel is configured for transmission using dynamic grant (DG) resources associated with a scheduling request (SR).
Aspect 24. The method of any of aspects 21-23, wherein the transmitting the one or more configurations comprises transmitting the logical channel configuration, wherein the receiving is based on the logical channel configuration, and wherein the logical channel configuration comprises the UL data transmission configuration.
Aspect 25. The method of any of aspects 21-24, wherein the UL data is associated with a medium access control (MAC) physical data unit (PDU) type, and wherein the UL data transmission configuration indicates that the MAC PDU type is configured for transmission using the common UL data resource pool.
Aspect 26. The method of any of aspects 21-25, further comprising: receiving, from the UE, assistance information indicating one or more logical channels, wherein the one or more configurations are based on the assistance information.
Aspect 27. The method of aspect 26, wherein the assistance information indicates that the first logical channel is preferred for transmission using the common UL data resource pool.
Aspect 28. The method of any of aspects 26-27, wherein the one or more logical channels are selected based on at least one of a maximum number of logical channels for transmission using the common UL data resource pool, or a minimum number of logical channels for transmission using the common UL data resource pool.
Aspect 29. The method of any of aspects 19-28, further comprising: receiving, from the UE, a delay status report, indicating one or more delay values for one or more logical channels, including the first logical channel, wherein the UL data transmission configuration is based on the delay status report.
Aspect 30. The method of any of aspects 19-29, wherein the UL data transmission configuration indicates a plurality of common UL data resource pools, the plurality of common UL data resource pools comprising the common UL data resource pool, wherein each of the plurality of common UL data resource pools is associated with one or more transmission reception points (TRPs) of a plurality of TRPs.
Aspect 31. The method of aspect 30, wherein the plurality of TRPs is associated with a corresponding plurality of transmission configuration indicator (TCI) states, wherein the UL data transmission configuration indicates, for each of the common UL data resource pools, one or more TCI states which can be used for UL transmissions.
Aspect 32. The method of any of aspects 19-31, wherein the UL data transmission configuration indicates: a plurality of common UL data resource pools, the plurality of common UL data resource pools comprising the common UL data resource pool; and for each of the common UL data resource pools, one or more control resource sets (CORESETS) which can be used for UL transmissions.
Aspect 33. The method of any of aspects 19-32, wherein the UL data transmission configuration indicates at least one of: a set of one or more physical channels that can be transmitted using the common UL data resource pool; or a set of one or more MAC-control element (CE) types that can be transmitted using the common UL data resource pool.
Aspect 34, a network unit, comprising: one or more memory devices; and one or more processors in communication with the one or more memory devices, wherein the network unit is configured to perform the steps of any of aspects 19-33.
Aspect 35, a non-transitory, computer-readable memory having program code recorded thereon, where the program code comprises instructions executable by one or more processors of a network unit to cause the network unit to perform the steps of any of aspects 19-33.
Aspect 36, a network unit, comprising: means for performing the steps of any of aspects 19-33.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A user equipment (UE), comprising:
one or more memory devices; and
one or more processors in communication with the one or more memory devices, wherein the UE is configured to:
receive, at a buffer for uplink (UL) transmissions, UL data associated with a first logical channel of a plurality of logical channels;
transmit, to a network unit and based on a common UL data resource pool, the UL data, wherein the UE is configured to transmit the UL data based on a UL data transmission configuration, and wherein the UL data transmission configuration indicates that the first logical channel is configured for transmission using the common UL data resource pool, wherein the common UL data resource pool comprises shared resources for use by a plurality of UEs for UL transmissions.

2. The UE of claim 1, wherein the UE is configured to transmit the UL data while in a non-connected state.

3. The UE of claim 1, wherein the UE is further configured to:
receive, from the network unit, one or more configurations, wherein the one or more configurations comprise one or more of:
a configuration of common resource pool for UL transmission;
a logical channel configuration;
a list of logical channels configured for the common UL data resource pool; or
a list of logical channel groups configured for the common UL data resource pool,
wherein the UL data transmission configuration is based on the one or more configurations.

4. The UE of claim 3, wherein the UL data transmission configuration indicates that a second logical channel is configured for transmission using configured grant (CG) resources.

5. The UE of claim 3, wherein the UL data transmission configuration indicates that a third logical channel is configured for transmission using dynamic grant (DG) resources associated with a scheduling request (SR).

6. The UE of claim 3, wherein the UE configured to receive the one or more configurations comprises the UE configured to receive the logical channel configuration, wherein the UE is configured to transmit the UL data based on the logical channel configuration, and wherein the logical channel configuration comprises the UL data transmission configuration.

7. The UE of claim 3, wherein the UL data is associated with a medium access control (MAC) physical data unit (PDU) type, and wherein the UL data transmission configuration indicates that the MAC PDU type is configured for transmission using the common UL data resource pool.

8. The UE of claim 3, wherein the UE is further configured to:
transmit, to the network unit, assistance information indicating one or more logical channels,
wherein the one or more configurations are based on the assistance information.

9. The UE of claim 8, wherein the assistance information indicates that the first logical channel is preferred for transmission using the common UL data resource pool.

10. The UE of claim 8, wherein the one or more logical channels are selected based on at least one of a maximum number of logical channels for transmission using the common UL data resource pool, or a minimum number of logical channels for transmission using the common UL data resource pool.

11. The UE of claim 1, wherein the UE is further configured to:
transmit, to the network unit, a delay status report, indicating one or more delay values for one or more logical channels, including the first logical channel,
wherein the UL data transmission configuration is based on the delay status report.

12. The UE of claim 1, wherein the UL data transmission configuration indicates a plurality of common UL data resource pools, the plurality of common UL data resource pools comprising the common UL data resource pool, wherein each of the plurality of common UL data resource pools is associated with one or more transmission reception points (TRPs) of a plurality of TRPs.

13. The UE of claim 12, wherein the plurality of TRPs is associated with a corresponding plurality of transmission configuration indicator (TCI) states, wherein the UL data transmission configuration indicates, for each of the common UL data resource pools, one or more TCI states which can be used for UL transmissions.

14. The UE of claim 1, wherein the UL data transmission configuration indicates:
a plurality of common UL data resource pools, the plurality of common UL data resource pools comprising the common UL data resource pool; and
for each of the common UL data resource pools, one or more control resource sets (CORESETS) which can be used for UL transmissions.

15. The UE of claim 1, wherein the UL data transmission configuration indicates at least one of:
a set of one or more physical channels that can be transmitted using the common UL data resource pool; or
a set of one or more MAC-control element (CE) types that can be transmitted using the common UL data resource pool.

16. A method of wireless communication performed by a user equipment (UE), the method comprising:
receiving, at a buffer for uplink (UL) transmissions, UL data associated with a first logical channel of a plurality of logical channels;
transmitting, to a network unit and based on a common UL data resource pool, the UL data, wherein the transmitting the UL data is based on a UL data transmission configuration, and wherein the UL data transmission configuration indicates that the first logical channel is configured for transmission using the common UL data resource pool, wherein the common UL data resource pool comprises shared resources for use by a plurality of UEs for UL transmissions.

17. The method of claim 16, further comprising:
receiving, from the network unit, one or more configurations, wherein the one or more configurations comprise one or more of:
a configuration of common resource pool for UL transmission;
a logical channel configuration;
a list of logical channels configured for the common UL data resource pool; or
a list of logical channel groups configured for the common UL data resource pool,
wherein the UL data transmission configuration is based on the one or more configurations.

18. The method of claim 17, wherein the receiving the one or more configurations comprises receiving the logical channel configuration, wherein the transmitting is based on the logical channel configuration, and wherein the logical channel configuration comprises the UL data transmission configuration.

19. The method of claim 17, further comprising:
transmitting, to the network unit, assistance information indicating one or more logical channels,
wherein the one or more configurations are based on the assistance information.

20. A user equipment (UE), comprising:
means for receiving, at a buffer for uplink (UL) transmissions, UL data associated with a first logical channel of a plurality of logical channels;
means for transmitting, to a network unit and based on a common UL data resource pool, the UL data, wherein the means for transmitting the UL data is based on a UL data transmission configuration, and wherein the UL data transmission configuration indicates that the first logical channel is configured for transmission using the common UL data resource pool, wherein the common UL data resource pool comprises shared resources for use by a plurality of UEs for UL transmissions.
